(19) United States
(12) Patent Application Publication
(10) Pub. No.: US 2017/0174150 A1
(43) Pub. Date: Jun. 22, 2017

(54) TRIM ASSEMBLY WITH ROBUST ATTACHMENT FEATURE

(71) Applicant: FORD GLOBAL TECHNOLOGIES, LLC, Dearborn, MI (US)

(72) Inventors: Bhavani Thota, Novi, MI (US); Linh Doan, Belleville, MI (US); Leonel de Jesus Perez Sandoval, Toluca (MX); Srivardhan Tallapragada, Royal Oak, MI (US)

(21) Appl. No.: 14/973,038

(22) Filed: Dec. 17, 2015

(51) Int. Cl. B60R 13/02

(52) U.S. Cl. CPC B60R 13/0206

(57) ABSTRACT

A trim assembly is provided. That trim assembly includes a trim applique having a mounting boss and a hook. The trim assembly also includes a bezel having a recess and a window. When properly assembled, the hook on the trim applique is received through the window of the bezel and the mounting boss on the trim applique is received in the recess of the bezel.

### TECHNICAL FIELD

This document relates generally to the motor vehicle equipment field and, more particularly, to a trim assembly including a trim applique connected to a receiving bezel by means of a new and improved robust attachment feature.

### BACKGROUND

Ornamental trim appliques are components that, due to styling requirements, tend to have somewhat complicated shapes. Such trim appliques are usually elongated and extremely narrow. This creates a significant difficulty when attempting to design a robust attachment feature for the assembly that will provide proper fastening and securing of the trim applique to the receiving bezel.

This document relates to a new and improved trim assembly incorporating a new and improved attachment feature that provides a sturdy location scheme while ensuring proper fit so that the trim applique and bezel remain connected together in place at all times.

### SUMMARY

In accordance with the purposes and benefits described herein, a new and improved trim assembly is provided. That trim assembly comprises a trim applique having a mounting boss and a hook and a bezel having a recess and a window. When fully assembled, the hook is received through the window and the mounting boss is received in the recess.

More specifically, the recess includes a rear wall. That rear wall may include an aperture. A fastener extends through the aperture and the mounting boss to secure the trim applique to the bezel.

The recess may also include a first section and a second section. The first section may have a first depth D₁ and the second section may have a second depth D₂ where D₂>D₁.

In some embodiments, the rear wall has a rear face including a beveled edge adjacent the window. Further, the hook defines a channel and the beveled edge is held in that channel.

In some embodiments, the rear wall has a front face including a chamfered transition section between the first section and the second section of the recess.

In some embodiments, the hook opens toward the mounting boss. Further, the hook may form an included angle of between about 22 and about 30 degrees. Still further, the hook may include a slot between a first reinforcing rib and a second reinforcing rib.

In the following description, there are shown and described several preferred embodiments of the trim assembly. As it should be realized, the trim assembly is capable of other, different embodiments and its several details are capable of modification in various, obvious aspects all without departing from the trim assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the trim assembly and together with the description serve to explain certain principles thereof. In the drawing figures:

FIG. 1 is a detailed perspective view of the mounting boss and hook provided on the rear face of the trim applique of the trim assembly.

FIG. 2 is a detailed perspective view of the recess and window included as a part of the bezel of the trim assembly that is adapted to receive and hold the trim applique illustrated in FIG. 1.

FIG. 3A is a perspective view illustrating how the trim applique is attached to the bezel.

FIG. 3B is a schematic illustration of how the attachment illustrated in FIG. 3A is completed.

FIG. 4 is a detailed view illustrating the completed trim assembly with the trim applique secured to the bezel.

FIG. 5 is a cross-section slice through the assembled trim assembly of FIG. 4 taken through the mounting boss and the hook.

Reference will now be made in detail to the present preferred embodiments of the trim assembly, examples of which are illustrated in the accompanying drawing figures.

### DETAILED DESCRIPTION

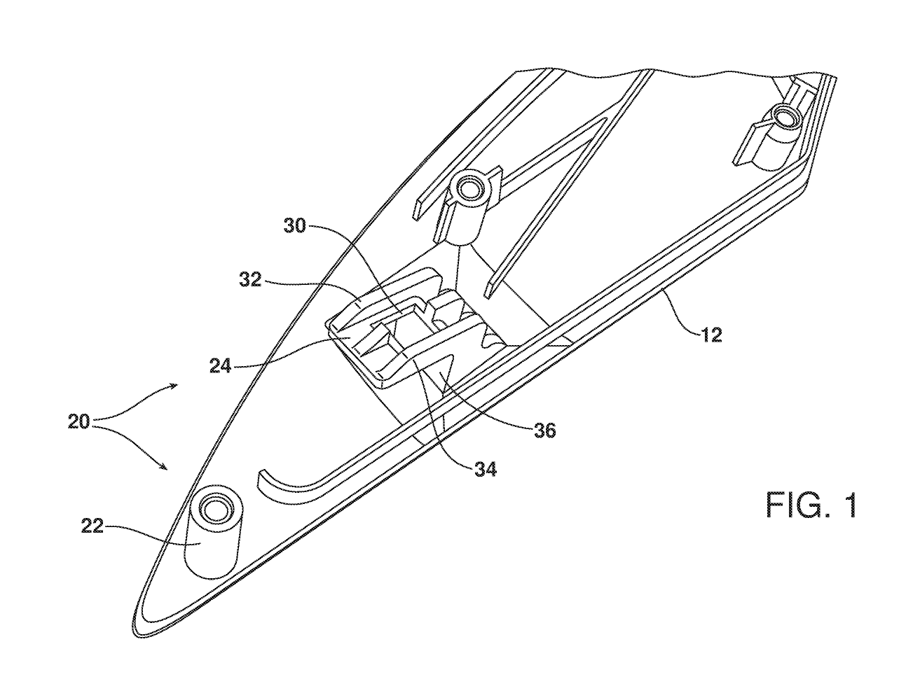

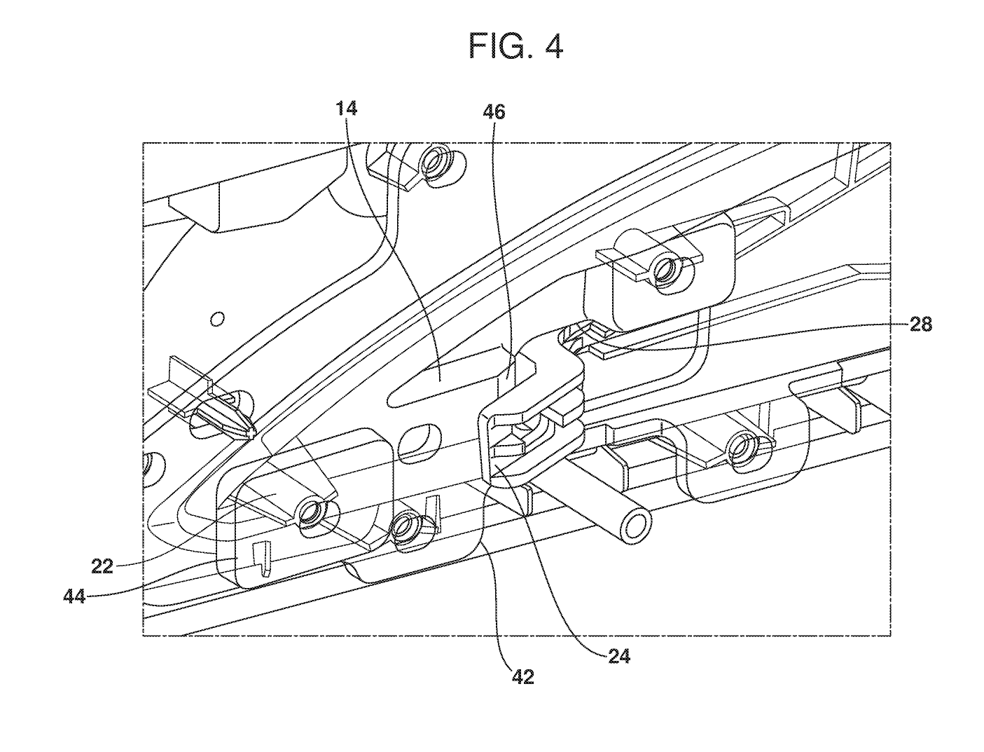

Reference is now made to FIGS. 1-5 illustrating the trim assembly 10 that includes a trim applique 12 that is connected to a receiving bezel 14. As is known in the art, the trim applique 12 may include an ornamental face 16 carried on a support 18. The ornamental face 16 may be made of any appropriate material including, but not limited to ornamental wood, carbon fiber, finished aluminum or other metal.

The trim applique 12 is connected to the bezel 14 by a new and improved attachment feature generally designated by reference numeral 20. That attachment feature 20 includes a mounting boss 22 and a hook 24 carried on the trim applique 12 and a cooperating recess 26 and a window 28 on a bezel 14. When assembled, the hook 24 is received through the window 28 and the mounting boss 22 is received in the recess 26.

As best illustrated in FIGS. 1, 4 and 5, the hook 24 may form an included angel of between about 22 and about 30 degrees and opens toward the mounting boss 22. In the illustrated embodiment, the hook 24 includes a slot 30 provided between a first reinforcing rib 32 and a second rib reinforcing rib 34. Such a structure aids in the injection molding process and serves to strengthen the hook 24. As further illustrated, the hook 24 forms or defines a channel 36, the function of which will be described in greater detail below.

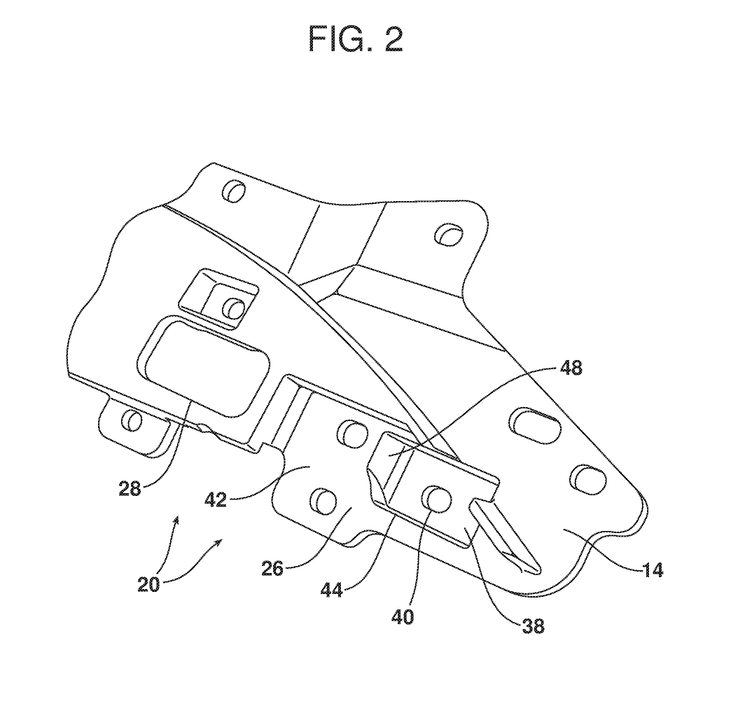

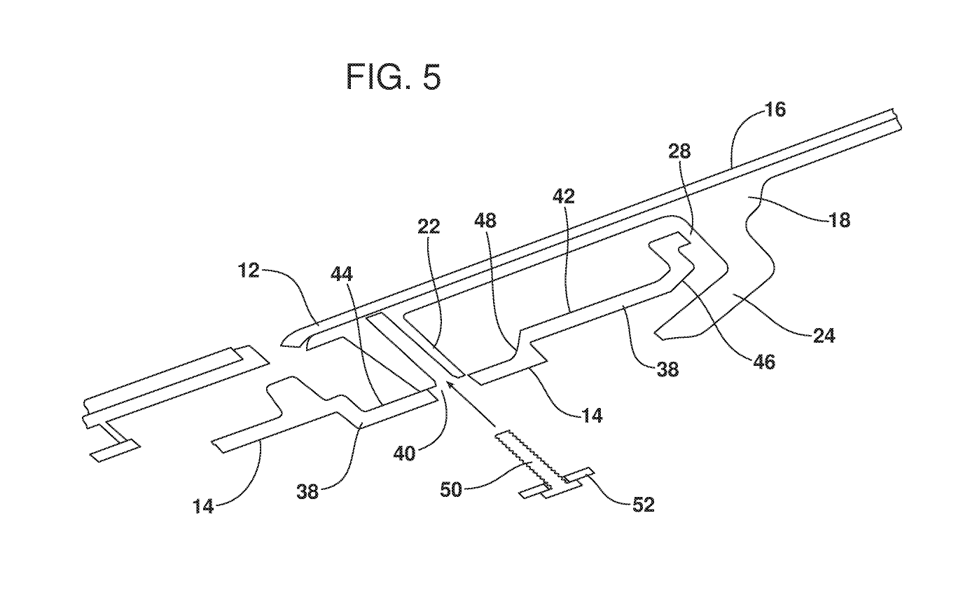

As best illustrated in FIGS. 2 and 5, the recess 26 includes a rear wall 38 having an aperture 40. In the illustrated embodiment the recess 26 includes a first section 42 and second section 44. The first section 42 has a first depth D₁ while the second section 44 has a second depth D₂ where D₂>D₁.

As best illustrated in FIG. 5, the rear wall 38 has a rear face including a beveled edge 46 provided adjacent the window 28. Further, the rear wall 38 has a front face including a chamfered transition section 48 between the first section 42 and second section 44 of the recess 26.

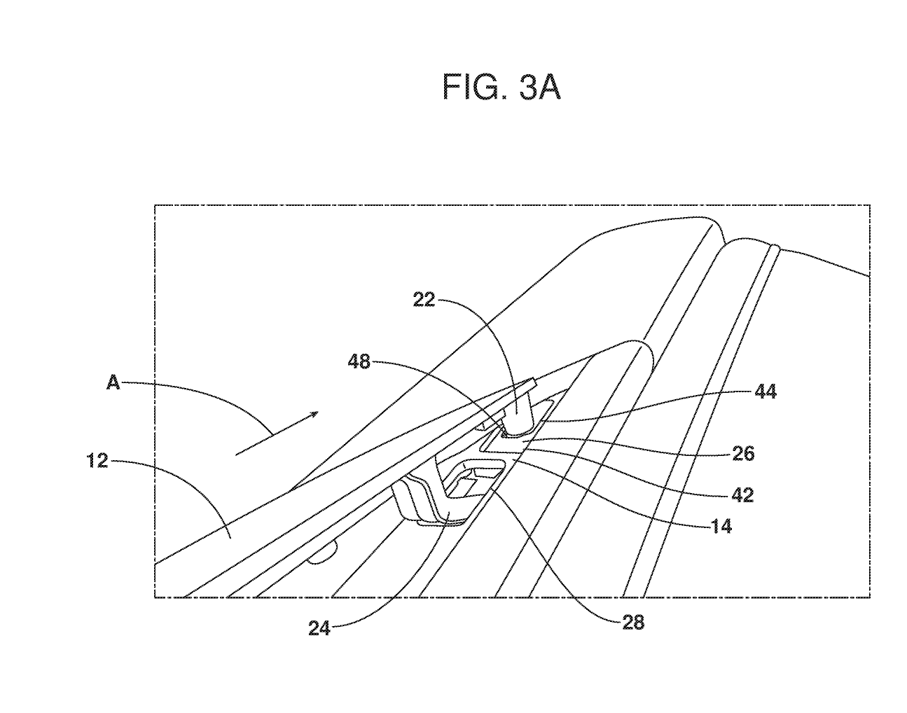

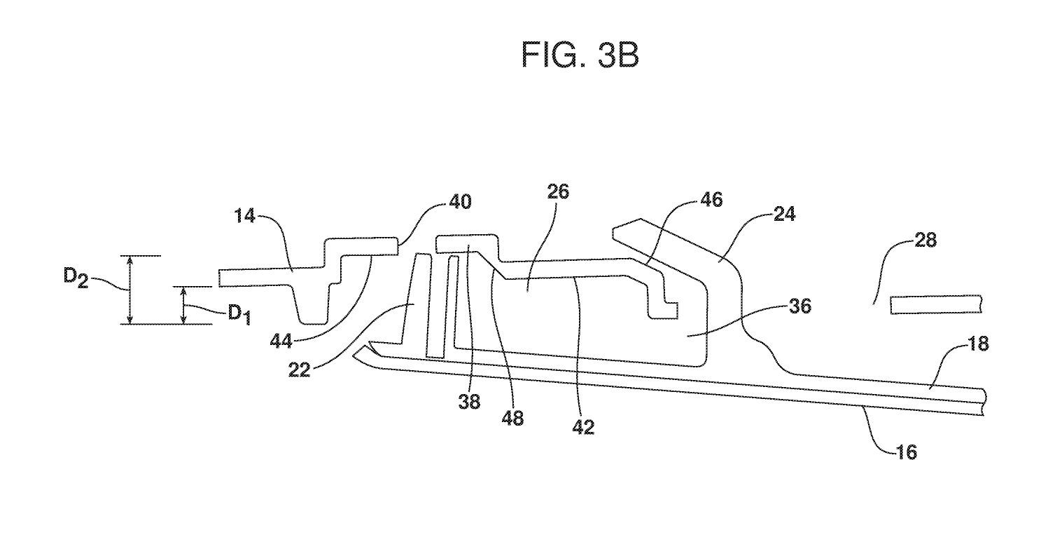

Reference is now made to FIGS. 3A and 3B illustrating how the trim applique 12 is connected to the bezel 14. As illustrated, the trim applique 12 is aligned with the bezel 14 with the hook 24 inserted through the window 28. The trim applique 12 is then pushed forward in the direction of action arrow A so that the beveled edge 46 of the rear wall 38 is received back in the channel 36 formed by the hook 24. Simultaneously, the mounting boss 22 slides down the chamfered transition section 48 from the first section 42 of the recess 26 to the second section 44 of the recess. As this sliding movement occurs, the trim applique 12 is also pivoted about the beveled edge 46. When the trim applique 12 is fully seated on the bezel 14, the mounting boss 22 is aligned with the aperture 40 in the second section 44 of the recess 26 and the beveled edge 46 of the rear wall 38 is fully seated at the bottom of the channel 36 formed by the hook 24 (see FIG. 5). A fastener, such as a screw 50, with cooperating retaining washer 52 is then received through the aperture 40 and engaged via threads with the mounting boss 22 in order to complete the connection.

As should be appreciated, the trim assembly 12 incorporates an attachment feature 20 that functions to readily align and locate a trim applique 12 with the bezel 14 in a simple and efficient manner. Advantageously, the hook 24 serves to hold the trim applique 12 steady with respect to the bezel 14 as the fastener/screw 50 is inserted through the aperture 40 in the rear wall 38 and engaged in the mounting boss 22 in order to complete the connection. It should further be appreciated that should the mounting boss 22 fail for any reason or the fastener 50 pull free for any reason, the hook 24 will still hold the trim applique 12 in place on the bezel 14.

The foregoing has been presented for purposes of illustration and description. It is not intended to be exhaustive or to limit the embodiments to the precise form disclosed. Obvious modifications and variations are possible in light of the above teachings. For example, while the trim applique 12 is secured to the bezel 14 by means of a screw fastener 50 in the illustrated embodiment, it should be appreciated that other types of fasteners could be utilized for this purpose including, for example, rib locks or clips. All such modifications and variations are within the scope of the appended claims when interpreted in accordance with the breadth to which they are fairly, legally and equitably entitled.

What is claimed:

1. A trim assembly, comprising:
a trim applique having a mounting boss and a hook;
a bezel having a recess and a window wherein said hook is received through said window and said mounting boss is received in said recess.

2. The trim assembly of claim 1, wherein said recess includes a rear wall having an aperture and a fastener extends through said aperture and said mounting boss to secure said trim applique to said bezel.

3. The trim assembly of claim 2, wherein said recess includes a first section and a second section.

4. The trim assembly of claim 3, wherein said first section has a first depth D₁ and said second section has a second depth D₂ where D₂>D₁.

5. The trim assembly of claim 4, wherein said rear wall has a rear face including a beveled edge adjacent said window.

6. The trim assembly of claim 5, wherein said hook defines a channel and said beveled edge is held in said channel.

7. The trim assembly of claim 6, wherein said rear wall has a front face including a chamfered transition section between said first section and said second section of said recess.

8. The trim assembly of claim 7, wherein said hook opens toward said mounting boss.

9. The trim assembly of claim 8, wherein said hook forms an included angle of between about 22 and about 30 degrees.

10. The trim assembly of claim 9, wherein said hook includes a slot between a first reinforcing rib and a second reinforcing rib.

11. The trim assembly of claim 1, wherein said recess includes a rear wall.

12. The trim assembly of claim 11, wherein said recess includes a first section and a second section.

13. The trim assembly of claim 12, wherein said first section has a first depth of D₁ and said second section has a second depth of D₂ where D₂>D₁.

14. The trim assembly of claim 13, wherein said rear wall has a rear face including a beveled edge adjacent said window.

15. The trim assembly of claim 14, wherein said hook defines a channel and said beveled edge is held in said channel.

16. The trim assembly of claim 15, wherein said rear wall has a front face including a chamfered transition section between said first section and said second section of said recess.

17. The trim assembly of claim 16, wherein said hook opens toward said mounting boss.

18. The trim assembly of claim 17, wherein said hook forms an included angle of between about 22 and about 30 degrees.

19. The trim assembly of claim 18, wherein said hook includes a slot between a first reinforcing rib and a second reinforcing rib.

20. The trim assembly of claim 1, wherein said hook opens toward said mounting boss.
